(19) United States
(12) Patent Application Publication
(10) Pub. No.: US 2026/0149400 A1
(43) Pub. Date: May 28, 2026

(54) MOTOR CONTROL SYSTEM AND MOTOR CONTROL METHOD

(71) Applicant: KYOCERA Document Solutions Inc., Osaka (JP)

(72) Inventor: Yusuke Ono, Osaka (JP)

(21) Appl. No.: 19/400,150

(22) Filed: Nov. 25, 2025

(30) Foreign Application Priority Data
Nov. 28, 2024 (JP) 2024-207164

(51) Int. Cl. H02P 23/14; G01P 3/481; G03G 15/00; G03G 21/10

(52) U.S. Cl. CPC H02P 23/14; G01P 3/481; G03G 15/5004; G03G 15/553; G03G 21/105

(57) ABSTRACT

A motor control system includes a first acquisition portion, a calculation portion, and a control portion. The first acquisition portion acquires a pulse that is output from a detection portion which detects rotational speed of a motor. The motor rotates a conveyor (screw) that conveys toner to be removed. The calculation portion calculates rotation speed of the motor in a specific period longer than a period of the pulse on the basis of the acquired pulse. The control portion controls the motor on the basis of the rotation speed calculated by the calculation portion such that the rotation speed of the motor is constant.

### INCORPORATION BY REFERENCE

This application is based upon and claims the benefit of priority from the corresponding Japanese Patent Application No. 2024-207164 filed on Nov. 28, 2024, the entire contents of which are incorporated herein by reference.

This disclosure relates to a motor control system and a motor control method.

### BACKGROUND

As the related art, an image forming apparatus has been known in which a motor power supply control portion that transmits driving force to a waste toner conveyance member has an increasing drive load because of a larger amount of toner in a waste toner collection container or the like. When it is time to switch, the motor power supply control portion in this image forming apparatus switches drive control over a motor from a continuous drive mode to an intermittent drive mode. In the continuous drive mode, the motor remains driven. In the intermittent drive mode, the motor is repeatedly driven and stopped.

### SUMMARY

A motor control system according to an aspect of this disclosure includes a first acquisition portion, a calculation portion, and a control portion. The first acquisition portion acquires a pulse that is output from a detection portion which detects rotational speed of a motor. The motor rotates a conveyor that conveys toner to be removed. The calculation portion calculates rotation speed of the motor in a specific period longer than a period of the pulse on the basis of the acquired pulse. The control portion controls the motor on the basis of the rotation speed calculated by the calculation portion such that the rotation speed of the motor is constant.

A motor control method according to another aspect of this disclosure includes an acquisition step, a calculation step, and a control step. In the acquisition step, a pulse that is output from a detection portion which detects rotational speed of a motor is acquired. The motor rotates a conveyor that conveys toner to be removed. In the calculation step, rotation speed of the motor is calculated in a specific period longer than a period of the pulse on the basis of the acquired pulse. In the control step, the motor is controlled on the basis of the rotation speed calculated in the calculation step such that the rotation speed of the motor is constant.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing a configuration of an image forming apparatus according to an embodiment.

FIG. 2 is a schematic diagram showing a configuration of a cleaning device of the image forming apparatus according to the embodiment.

FIG. 3 is a block diagram showing the configuration of the image forming apparatus according to the embodiment.

FIG. 4 is a diagram showing an example of data to which a control portion of a motor control system according to the embodiment refers.

FIG. 5 is a flowchart showing an operation example of the motor control system according to the embodiment.

FIG. 6 is a diagram showing an example in which the motor control system according to the embodiment controls a motor.

FIG. 7 is a block diagram showing a configuration of an image forming apparatus according to a modification of the embodiment.

FIG. 8 is a flowchart showing an operation example of a motor control system according to the modification of the embodiment.

### DETAILED DESCRIPTION

Hereinafter, an embodiment of this disclosure will be described with reference to the accompanying drawings. The following embodiment is a specific example of this disclosure and is not intended to limit the technical scope of this disclosure.

### [1] Overall Configuration of Image Forming Apparatus

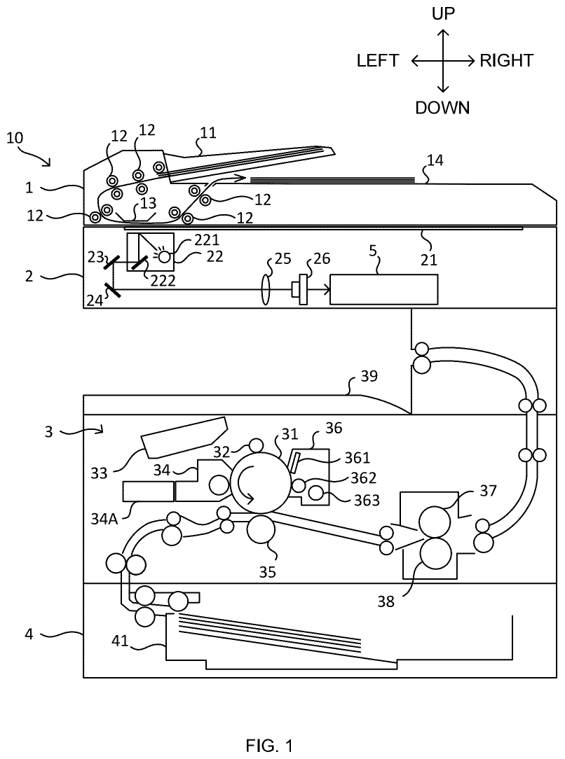

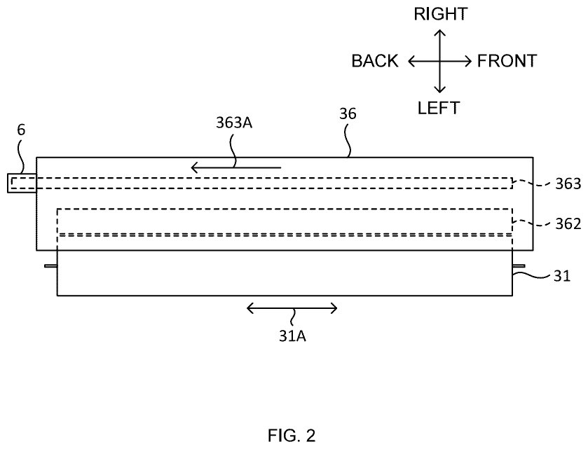

First, the outlined configuration of an image forming apparatus 10 according to this embodiment will be described with reference to FIGS. 1 and 2. FIG. 1 is a schematic cross-sectional view of the image forming apparatus 10. FIG. 2 is a schematic top view of the configuration of a cleaning device 36. It is noted that the following description defines the directions up, down, left, and right using arrows indicating the directions in FIG. 1. In addition, the following description defines the foreground side of a diagram as the front of the image forming apparatus 10 and the background side of a diagram as the back of the image forming apparatus 10. Needless to say, the definition of the directions described above does not intend to limit how the image forming apparatus 10 is used.

In this embodiment, the image forming apparatus 10 is, as an example, a multifunction peripheral having a plurality of functions such as a scan function, a facsimile function, and a copy function in addition to a printer function of forming an image on the basis of image data. It is noted that the image forming apparatus 10 may be, for example, an apparatus such as a printer apparatus, a facsimile apparatus, and a copier.

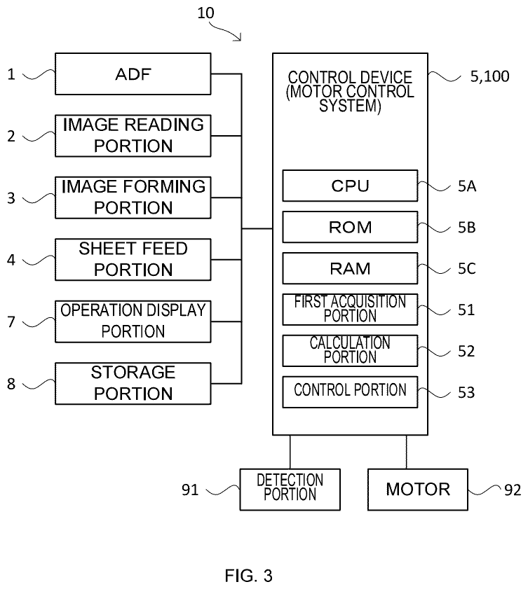

As shown in FIG. 1, the image forming apparatus 10 includes an ADF 1, an image reading portion 2, an image forming portion 3, a sheet feed portion 4, a control device 5, a discharge portion 6 (see FIG. 2), an operation display portion 7 (see FIG. 3), a storage portion 8 (see FIG. 3), and the like.

As shown in FIG. 1, the ADF 1 is an automatic document sheet conveying device including a document sheet set portion 11, a plurality of conveying rollers 12, a document sheet holding portion 13, and a sheet discharge portion 14. In the ADF 1, each of the conveying rollers 12 is driven by a motor (not shown) to convey a sheet placed on the document sheet set portion 11 to the sheet discharge portion 14 through the reading position of image data by the image reading portion 2. This allows the image reading portion 2 to read the image data from the sheet conveyed by the ADF 1.

As shown in FIG. 1, the image reading portion 2 includes a document sheet table 21, a reading unit 22, mirrors 23 and 24, an optical lens 25, and a charge-coupled device (CCD) 26. The document sheet table 21 is a placement portion for a sheet. The placement portion is provided on the upper surface of the image reading portion 2. The reading unit 22 includes an LED light source 221 and a mirror 222. The reading unit 22 is movable in a sub-scanning direction (the left-right direction here) using a motor (not shown). The LED light source 221 includes a large number of white LEDs arranged along a main scanning direction (the front-back direction here). The mirror 222 reflects, toward the mirror 23, light emitted from the LED light source 221 and reflected by the surface of a sheet at the reading position on the document sheet table 21. The light reflected by the mirror 222 is then guided to the optical lens 25 by the mirrors 23 and 24. The optical lens 25 condenses the incoming light and causes the condensed light to enter the CCD 26. The CCD 26 includes a photoelectric conversion element or the like that inputs an electrical signal corresponding to the amount of received light coming from the optical lens 25 to the control device 5 as image data of the sheet.

The image forming portion 3 is an electrophotographic image forming portion capable of executing an image formation process (print process) of forming an image on the basis of the image data read by the image reading portion 2. In addition, the image forming portion 3 is also capable of executing an image formation process on the basis of image data received from an information processing apparatus such as an external personal computer.

Specifically, the image forming portion 3 includes a photoconductor drum 31, a charging device 32, a laser scanning unit (LSU) 33, a developing device 34, a transfer roller 35, the cleaning device 36, a fixing roller 37, a pressure roller 38, and a sheet discharge tray 39 as shown in FIG. 1. In the image forming portion 3, an image is then formed, in the following procedures, on a sheet supplied from a sheet feed cassette 41 attachable to and detachable from the sheet feed portion 4 described below and the sheet on which the image is formed is discharged to the sheet discharge tray 39. It is noted that the sheet is paper, coated paper, postcard paper, an envelope, an OHP sheet, or the like.

Hereinafter, an operation of the image forming portion 3 will be described in detail. First, the charging device 32 evenly charges the photoconductor drum 31 at a predetermined potential. Next, the laser scanning unit 33 emits light based on the image data to the surface of the photoconductor drum 31. This forms an electrostatic latent image corresponding to the image data on the surface of the photoconductor drum 31. The electrostatic latent image on the photoconductor drum 31 is then developed (visualized) by the developing device 34 as a toner image. It is noted that the developing device 34 is replenished with toner (developer) from a toner container 34A attachable to and detachable from the image forming portion 3. Subsequently, the toner image formed on the photoconductor drum 31 is transferred to a sheet by the transfer roller 35. After that, the toner image transferred to the sheet is heated, and fused and fixed by the fixing roller 37 when the sheet passes between the fixing roller 37 and the pressure roller 38.

Meanwhile, the toner remaining on the surface of the photoconductor drum 31 is removed by the cleaning device 36. Specifically, the cleaning device 36 includes a cleaning member 361, a polishing roller 362, and a screw 363 as shown in FIGS. 1 and 2. The cleaning member 361 is a blade-shaped member that removes the remaining toner adhering to the surface of the photoconductor drum 31. The polishing roller 362 sticks the toner removed by the cleaning member 361 to the surface and polishes the surface of the photoconductor drum 31. The screw 363 conveys the toner removed by the cleaning member 361 to the discharge portion 6 described below along an axial direction 31A of the photoconductor drum 31. Here, the screw 363 is an example of a conveyor according to this disclosure.

The sheet feed portion 4 includes the sheet feed cassette 41 and a plurality of conveying rollers 42. The sheet feed cassette 41 is attachable to and detachable from the apparatus body of the image forming apparatus 10. In the sheet feed portion 4, each of the conveying rollers 42 is driven by a motor (not shown) to supply a sheet placed in the sheet feed cassette 41 to the image forming portion 3.

The control device 5 integrally controls the image forming apparatus 10. In addition, the control device 5 functions as a motor control system 100 described below. As shown in FIG. 3, the control device 5 includes a CPU 5A, a ROM 5B, and a RAM 5C. The CPU 5A is a processor that executes various calculation processes. The ROM 5B is a non-volatile storage device that stores, in advance, information about control programs or the like for causing the CPU 5A to execute various processes. The RAM 5C is a volatile storage device that is used as a temporary storage memory (work area) for the various processes which are executed by the CPU 5A.

In the control device 5, the CPU 5A executes the various control programs stored in advance in the ROM 5B. The image forming apparatus 10 is hereby controlled by the control device 5 integrally and the control device 5 functions as the motor control system 100. It is noted that the control device 5 may be composed of an electronic circuit such as an integrated circuit (ASIC). In addition, the control device 5 may be a control portion provided separately from a main control portion which integrally controls the image forming apparatus 10.

As shown in FIG. 2, the discharge portion 6 is disposed to project in the axial direction 31A from the rear end of the housing of the cleaning device 36 in association with the position of the screw 363 disposed in the cleaning device 36. Here, the screw 363 conveys toner in a conveyance direction 363A that is the same direction as the projecting direction of the discharge portion 6. The front end of the screw 363 in the conveyance direction 363A then extends to the discharge portion 6. The toner removed from the surface of the photoconductor drum 31 is therefore conveyed to the discharge portion 6 by the screw 363. The toner conveyed to the discharge portion 6 is discharged to a toner storage container (not shown) through a discharge port (not shown) of the discharge portion 6. The toner storage container is attachable to and detachable from the discharge portion 6 and stores toner.

The operation display portion 7 is a user interface of the image forming apparatus 10. The operation display portion 7 includes a display portion such as a liquid-crystal display that displays various kinds of information in response to a control instruction from the control device 5 and an operation portion such as an operation key or a touch panel that inputs various kinds of information to the control device 5 in response to an operation of a user.

The storage portion 8 is a non-volatile storage device. For example, the storage portion 8 is a storage device including a non-volatile memory such as a flash memory and an EEPROM (registered trademark), a solid state drive (SSD), a hard disk drive (HDD), and the like.

Incidentally, as the related art, an image forming apparatus has been known in which a motor power supply control portion that transmits driving force to a waste toner conveyance member has an increasing drive load because of a larger amount of toner in a waste toner collection container or the like. When switching time comes, the motor power supply control portion in this image forming apparatus switches drive control over a motor from a continuous drive mode to an intermittent drive mode. In the continuous drive mode, the motor remains driven. In the intermittent drive mode, the motor is repeatedly driven and stopped. For example, it has been known that an image forming apparatus like the image forming apparatus 10 is configured to collect the toner (in other words, the waste toner or the transfer residual toner) removed from the surface of a photoconductor drum. In the configuration, a motor is controlled to drive a conveyance member (e.g., a screw or the like), thereby conveying the toner to a toner collection container through a discharge portion. Here, a configuration in which the drive control over the motor is switched from a continuous drive mode in which the motor remains driven to an intermittent drive mode in which the motor is repeatedly driven and stopped, for example, in the case of a larger amount of toner in the toner collection container or the like has been known as the related art.

However, the related art does not have a function of controlling the rotation speed of the motor and switches the continuous drive mode and the intermittent drive mode by controlling only the driving or the stop of the motor. The related art therefore has a problem with the possibility that a smaller amount of toner is collected per unit time in the intermittent drive mode and a toner clog is more easily caused. For example, in a case where the motor is intermittently driven like the related art, the conveyance member collects a smaller amount of toner per unit time in comparison with the continuously driven motor. As a result, the problem is raised with the possibility that the toner is not completely removed from the surface of the photoconductor drum and a toner clog is more easily caused.

To solve the problem, it is conceivable to perform control to keep the rotation speed of the motor constant. This, however, raises a problem that the processing load related to the control over the motor tends to increase. Specifically, it is conceivable to execute feedback control of performing control on the basis of the rotation speed of the motor to keep the rotation speed of the motor constant. In this feedback control, a pulse output, for example, from a detection portion such as an encoder that detects the rotational speed of the motor is acquired and the rotation speed of the motor is calculated from the acquired pulse. However, in a case where the feedback control is executed whenever a pulse from the detection portion is acquired, the processing load tends to increase. For example, in a case where a pulse output from the detection portion has a period of several kHz, the feedback control is executed several thousand times per second.

In contrast, in this embodiment, a process that is executed by the motor control system 100 of the image forming apparatus 10 described below allows the motor control system 100 and a motor control method to be implemented that each facilitate the processing load related to the control over the motor to be reduced while keeping the rotation speed of the motor constant.

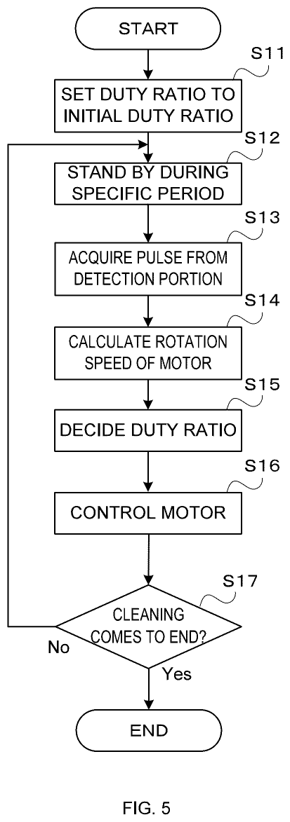

Specifically, the ROM 5B of the control device 5 stores, in advance, a program for causing the CPU 5A to execute feedback control (see FIG. 5) described below. It is noted that the program may be recorded in a computer-readable recording medium such as a CD, a DVD, or a flash memory, and read from the recording medium and installed in the storage portion 8.

The control device 5 (motor control system 100) then includes a first acquisition portion 51, a calculation portion 52, and a control portion 53 as shown in FIG. 3. Specifically, the control device 5 executes the program stored in the ROM 5B using the CPU 5A. The control device 5 hereby functions as the first acquisition portion 51, the calculation portion 52, and the control portion 53.

The first acquisition portion 51 acquires a pulse that is output from a detection portion 91 which detects the rotational speed of a motor 92. The motor 92 rotates a conveyor (the screw 363 here) that conveys toner to be removed (waste toner or transfer residual toner). In this embodiment, the detection portion 91 is an encoder attached to the motor 92. More specifically, the detection portion 91 is a rotary encoder.

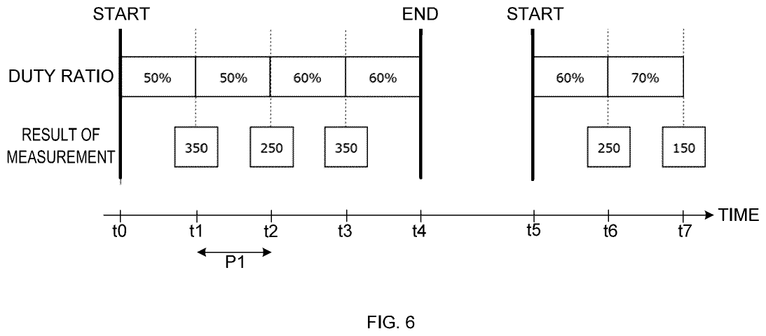

The calculation portion 52 calculates the rotation speed of the motor 92 in a specific period P1 (see FIG. 6) longer than the period of the pulse output from the detection portion 91 on the basis of the pulse acquired from the first acquisition portion 51. Specifically, the calculation portion 52 repeats a series of processes of standing by without measuring the frequency of a pulse during the specific period P1, measuring the frequency of a pulse acquired by the first acquisition portion 51 when the specific period P1 passes, and standing by again during the specific period P1 after the measurement. It is noted that the calculation portion 52 may repeat a series of processes described below. In the series of processes, an operation of the first acquisition portion 51 remains stopped during the specific period P1, the first acquisition portion 51 is brought into operation and the frequency of a pulse is measured when the specific period P1 passes, and the operation of the first acquisition portion 51 remains stopped again during the specific period P1 after the measurement. Here, the frequency of a pulse is proportional to the rotation speed of the motor 92. Therefore, the calculation portion 52 substantially calculates the rotation speed of the motor 92. Needless to say, the calculation portion 52 may calculate the rotation speed of the motor 92 itself.

In the embodiment, the specific period P1 has a length of about several seconds. It is sufficient if the specific period P1 is a period that allows the rotation speed of the motor 92 to remain constant under feedback control. For example, it is preferable that the specific period P1 be five seconds or less. Furthermore, it is preferable that the specific period P1 be one second or more and five seconds or less. Needless to say, the specific period P1 may be any period as long as the specific period P1 is longer than the period of a pulse output from the detection portion 91. The specific period P1 does not therefore have to have a length of about several seconds, but it is preferable that the specific period P1 have a length of about several seconds to reduce the processing load related to the control over the motor 92 as much as possible.

The control portion 53 controls the motor 92 on the basis of the rotation speed of the motor 92 calculated by the calculation portion 52 such that the rotation speed of the motor 92 is constant. In this embodiment, the control portion 53 controls the motor 92 on the basis of the frequency of the pulse output from the detection portion 91 that is measured by the calculation portion 52 to keep the rotation speed of the motor 92 constant at reference speed set in advance.

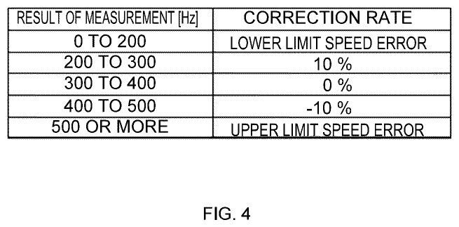

In the embodiment, the control portion 53 performs pulse width modulation (PWM) control on the motor 92. Specifically, the control portion 53 decides the duty ratio of a control signal on the basis of the rotation speed calculated by the calculation portion 52 by referring to, for example, data (see FIG. 4) stored in advance in the ROM 5B. Here, the control signal is a binary signal for an instruction to turn on/off a voltage to be supplied to the motor 92 from a power supply (not shown).

In FIG. 4, the “result of measurement” indicates a result of the measurement of the frequency of a pulse output from the detection portion 91 by the calculation portion 52. In other words, the “result of measurement” indicates a result of the measurement of the rotation speed of the motor 92 by the calculation portion 52. In addition, in FIG. 4, the “correction rate” indicates a correction rate based on the current duty ratio of a control signal. For example, in a case where the current duty ratio of a control signal is 50%, the duty ratio of the control signal is decided as 50%+10%=60% if the “correction rate” is 10%.

It is noted that the “lower limit speed error” in FIG. 4 indicates a case where the rotation speed of the motor 92 is lower than the lower limit value of a normal speed range and the “upper limit speed error” indicates a case where the rotation speed of the motor 92 is higher than the upper limit value of the normal speed range. In a case where the “correction rate” indicates the “lower limit speed error” or the “upper limit speed error”, the control portion 53 stops the motor 92. In addition, in this case, the control portion 53 may notify a user of the occurrence of an error, for example, through the operation display portion 7.

In this embodiment, the control portion 53 controls the motor 92 by deciding the duty ratio of a control signal such that the rotation speed of the motor 92 falls within the range of the reference speed. In other words, the control portion 53 controls the motor 92 by deciding the duty ratio of a control signal such that the rotational speed (the frequency of a pulse output from the detection portion 91) of the motor 92 falls within a predetermined range (300 to 400 Hz here).

### [2] Operation Example of Motor Control System

The following describes an example of the motor control method according to this embodiment along with examples of procedures of processes that are executed by the control device 5 (motor control system 100) in the image forming apparatus 10 with reference to FIG. 5. Here, steps S11, S12, . . . denote the numbers of processing procedures (steps) that are executed by the motor control system 100. The processes are started when the cleaning device 36 removes the toner remaining on the surface of the photoconductor drum 31.

### <Step S11>

First, the first acquisition portion 51 sets the duty ratio of a control signal to an initial duty ratio. Here, the initial duty ratio is set depending on the reference speed of the rotation speed of the motor 92 and stored in advance, for example, in the ROM 5B.

### <Step S12>

Next, the calculation portion 52 stands by without measuring the frequency of a pulse during the specific period P1 (e.g., one second). It is noted that the calculation portion 52 may keep an operation of the first acquisition portion 51 stopped during the specific period P1.

### <Step S13>

When the specific period P1 passes, the first acquisition portion 51 acquires a pulse from the detection portion 91. Additionally, in a case where the calculation portion 52 stops an operation of the first acquisition portion 51, step S13 may be constantly in execution.

### <Step S14>

Next, the calculation portion 52 calculates the rotation speed of the motor 92 on the basis of the pulse acquired by the first acquisition portion 51. Specifically, the calculation portion 52 indirectly calculates the rotation speed of the motor 92 by measuring the frequency of the pulse acquired by the first acquisition portion 51.

### <Step S15>

Next, the control portion 53 decides the duty ratio of the control signal by referring to the data shown in FIG. 4 on the basis of the rotation speed (the frequency of the pulse here) of the motor 92 calculated by the calculation portion 52.

### <Step S16>

The control portion 53 then performs feedback control on the motor 92 by performing PWM control on the motor 92 using a control signal having the duty ratio decided in step S15. The motor 92 is hereby controlled such that the rotation speed of the motor 92 is constant.

### <Step S17>

After that, steps S12 to S16 are repeated until a process of removing the toner by the cleaning device 36, that is, cleaning, comes to an end (step S17: No). Then, an operation of the motor control system 100 also comes to an end when cleaning by the cleaning device 36 comes to an end (step S17: Yes).

The following describes a specific example of an operation of the motor control system 100 with reference to FIG. 6. First, an operation of the motor control system 100 is started at time t0. When the operation of the motor control system 100 is started, the control portion 53 sets the duty ratio of a control signal to the initial duty ratio (50% here).

Next, the calculation portion 52 measures the frequency of a pulse output from the detection portion 91 at time t1 the specific period P1 (e.g., one second) after the time t0. The control portion 53 then decides the duty ratio of the control signal on the basis of a result of the measurement of the frequency of the pulse. Here, the result of the measurement of the frequency of the pulse indicates 350 Hz. The control portion 53 therefore determines that the correction rate is 0% by referring to the data shown in FIG. 4, and keeps the current duty ratio (50% here) instead of changing the current duty ratio.

Next, the calculation portion 52 measures the frequency of a pulse output from the detection portion 91 at time t2 the specific period P1 after the time t1. The control portion 53 then decides the duty ratio of the control signal on the basis of a result of the measurement of the frequency of the pulse. Here, the result of the measurement of the frequency of the pulse indicates 250 Hz. The control portion 53 therefore determines that the correction rate is 10% by referring to the data shown in FIG. 4, and changes the current duty ratio to 50%+10%=60%.

Next, the calculation portion 52 measures the frequency of a pulse output from the detection portion 91 at time t3 the specific period P1 after the time t2. The control portion 53 then decides the duty ratio of the control signal on the basis of a result of the measurement of the frequency of the pulse. Here, the result of the measurement of the frequency of the pulse indicates 350 Hz. The control portion 53 therefore determines that the correction rate is 0% by referring to the data shown in FIG. 4, and keeps the current duty ratio (60% here) instead of changing the current duty ratio.

After that, when the operation of the motor control system 100 comes to an end at time t4, the control portion 53 updates the initial duty ratio to the duty ratio at the time of the end of the operation. Here, the initial duty ratio is updated from 50% to 60%.

When an operation of the motor control system 100 is started again at time t5 after the operation of the motor control system 100 comes to an end, the control portion 53 sets the duty ratio of a control signal to the initial duty ratio (60% here). In other words, the control portion 53 sets the duty ratio at which the motor control system 100 came to an end last time. That is, in this embodiment, in a case where the motor 92 starts to be driven, the control portion 53 starts to drive the motor 92 at the rotation speed at which the motor 92 is stopped last time. This makes it possible to drive the motor 92 with the same operation load as the operation load for collecting toner last time. This offers an advantage that the rotation speed of the motor 92 less varies whenever the motor 92 is driven.

Next, the calculation portion 52 measures the frequency of a pulse output from the detection portion 91 at time t6 the specific period P1 after the time t5. The control portion 53 then decides the duty ratio of the control signal on the basis of a result of the measurement of the frequency of the pulse. Here, the result of the measurement of the frequency of the pulse indicates 250 Hz. The control portion 53 therefore determines that the correction rate is 10% by referring to the data shown in FIG. 4, and changes the current duty ratio to 60%+10%=70%.

Next, the calculation portion 52 measures the frequency of a pulse output from the detection portion 91 at time t7 the specific period P1 after the time t6. The control portion 53 then decides the duty ratio of the control signal on the basis of a result of the measurement of the frequency of the pulse. Here, the result of the measurement of the frequency of the pulse indicates 150 Hz. The control portion 53 therefore determines that a lower limit speed error occurs by referring to the data shown in FIG. 4, and stops the motor 92.

As described above, the motor control system 100 according to this embodiment calculates the rotation speed of the motor 92 in the specific period P1 longer than the period of a pulse output from the detection portion 91. The motor control system 100 according to this embodiment then controls the motor 92 on the basis of the calculated rotation speed of the motor 92 such that the rotation speed of the motor 92 is constant. This facilitates the motor control system 100 according to this embodiment to reduce the processing load related to the control over the motor 92 in comparison with a case where the rotation speed of the motor 92 is calculated whenever a pulse is acquired from the detection portion 91. In addition, the motor control system 100 according to this embodiment controls the motor 92 such that the rotation speed of the motor 92 is constant in each of the specific periods P1. This facilitates the rotation speed of the motor 92 to remain constant and makes it easier to reduce the possibility that the toner is not completely removed from the surface of the photoconductor drum 31 and a toner clog is more easily caused.

### [3] Modification

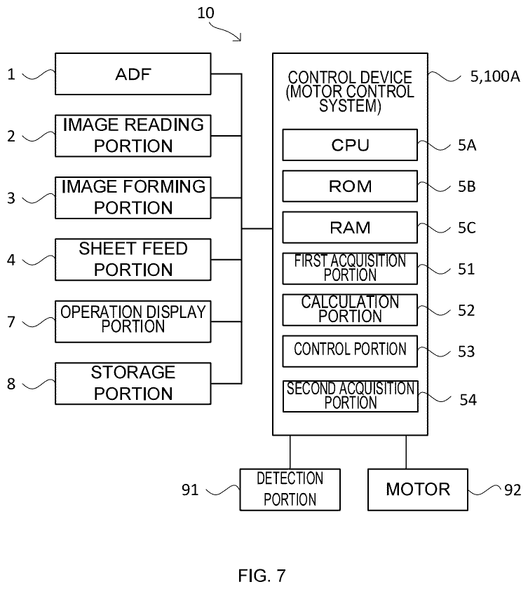

FIG. 7 is a block diagram showing the configuration of the image forming apparatus 10 including a motor control system 100A according to a modification of the embodiment. The motor control system 100A is different from the motor control system 100 according to the embodiment in that the motor control system 100A further includes a second acquisition portion 54 in this modification. The following omits the description of what is common to that of the motor control system 100 according to the embodiment.

The second acquisition portion 54 acquires a parameter indicating the remaining amount of conveyed toner. For example, the second acquisition portion 54 is a timer. The second acquisition portion 54 measures the elapsed time from the time point at which the toner is replaced with unused toner, thereby acquiring the elapsed time as a parameter. In addition, for example, the second acquisition portion 54 is a remaining-amount sensor disposed in the toner collection container. The second acquisition portion 54 detects the remaining amount of conveyed toner, thereby acquiring the remaining amount as a parameter.

In this modification, the control portion 53 then changes the specific period P1 depending on the parameter acquired by the second acquisition portion 54. For example, the control portion 53 makes the specific period P1 longer as the elapsed time is shorter. As the elapsed time is longer, the control portion 53 makes the specific period P1 shorter. In addition, for example, the control portion 53 makes the specific period P1 longer as the remaining amount is larger. As the remaining amount is smaller, the control portion 53 makes the specific period P1 shorter.

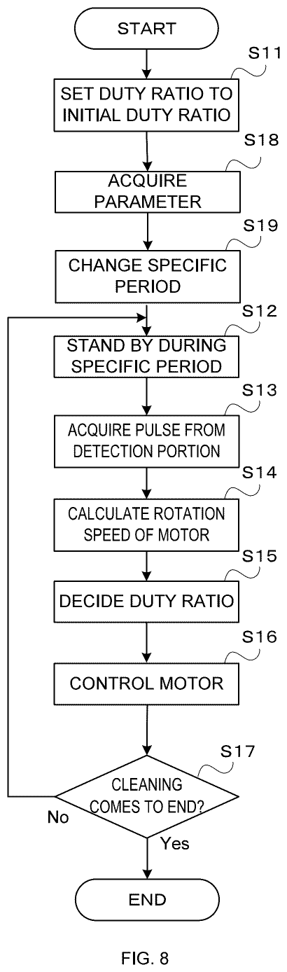

The following describes an example of a motor control method according to this modification along with examples of procedures of processes that are executed by the motor control system 100A according to this modification with reference to FIG. 8. Here, steps S11, S12, . . . denote the numbers of processing procedures (steps) that are executed by the motor control system 100A. The processes are started when the cleaning device 36 removes the toner remaining on the surface of the photoconductor drum 31. It is noted that steps S11 to S17 are the same as the operations of the motor control system 100 according to the embodiment and will not be thus described here.

Steps S18 and S19 described below are executed, for example, between step S11 and step S12. It is noted that steps S18 and S19 may be executed before step S11 or may be executed in parallel with step S11.

<step S18>

The second acquisition portion 54 acquires a parameter indicating the remaining amount of conveyed toner.

### <Step S19>

Next, the control portion 53 changes the specific period P1 depending on the parameter acquired by the second acquisition portion 54.

As described above, in this modification, the specific period P1 is changed depending on the remaining amount of conveyed toner. This modification therefore has an advantage that it is easier to set the appropriate specific period P1 which both reduces the processing load related to the control over the motor 92 and keeps the rotation speed of the motor 92 constant. For example, in a case where the remaining amount of conveyed toner is small, the drive load of the motor 92 necessary to convey toner is light. This makes it easier to keep the rotation speed of the motor 92 constant while reducing the processing load related to the control over the motor 92 by making the specific period P1 relatively long. In contrast, in a case where the remaining amount of conveyed toner is large, the drive load of the motor 92 necessary to convey toner is heavier. This makes it easier to keep the rotation speed of the motor 92 constant by making the specific period P1 relatively short. In this embodiment, when an operation of the motor control system 100 comes to an end, the control portion 53 updates the initial duty ratio to the duty ratio at the time of the end, but the initial duty ratio does not have to be updated.

In this embodiment, the control portion 53 may make the specific period P1 longer in a case where the correction rate is 0% in the process of deciding the duty ratio, that is, in a case where the duty ratio in the PWM control is not updated. For example, in a case where the specific period P1 at the time of the execution of the process of deciding the duty ratio is one second, the control portion 53 may set the next or later specific period P1 to 1.5 seconds or the like. The control portion 53 may then make the specific period P1 longer in the respective processes of deciding the duty ratio as long as the situation in which the duty ratio is not updated continues. This offers an advantage that it is further easier to reduce the processing load related to the control over the motor 92 while keeping the rotation speed of the motor 92 constant. It is, however, preferable to set the upper limit value of the specific period P1 within a range that makes it possible to keep the rotation speed of the motor 92 constant. In addition, the control portion 53 may reset the specific period P1 in a case where the duty ratio is updated.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### <Supplementary Note 1>

A motor control system including:

a first acquisition portion configured to acquire a pulse that is output from a detection portion configured to detect rotational speed of a motor configured to rotate a conveyor configured to convey toner to be removed;

a calculation portion configured to calculate rotation speed of the motor in a specific period longer than a period of the pulse on the basis of the acquired pulse; and

a control portion configured to control the motor on the basis of the rotation speed calculated by the calculation portion such that the rotation speed of the motor is constant.

### <Supplementary Note 2>

The motor control system according to Supplementary Note 1, in which the control portion performs PWM control on the motor.

### <Supplementary Note 3>

The motor control system according to Supplementary Note 2, in which the control portion makes the specific period longer in a case where a duty ratio in the PWM control is not updated.

### <Supplementary Note 4>

The motor control system according to any one of Supplementary Notes 1 to 3, further including a second acquisition portion configured to acquire a parameter of at least one of elapsed time from use of the toner and a remaining amount of the toner, in which

the control portion changes the specific period depending on the parameter.

### <Supplementary Note 5>

The motor control system according to any one of Supplementary Notes 1 to 4, in which, in a case where the motor starts to be driven, the control portion starts to drive the motor at rotation speed at which the motor is stopped last time.

### <Supplementary Note 6>

A motor control method including:

an acquisition step of acquiring a pulse that is output from a detection portion configured to detect rotational speed of a motor configured to rotate a conveyor configured to convey toner to be removed;

a calculation step of calculating rotation speed of the motor in a specific period longer than a period of the pulse on the basis of the acquired pulse; and

a control step of controlling the motor on the basis of the rotation speed calculated in the calculation step such that the rotation speed of the motor is constant.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A motor control system comprising:
a first acquisition portion configured to acquire a pulse that is output from a detection portion configured to detect rotational speed of a motor configured to rotate a conveyor configured to convey toner to be removed;
a calculation portion configured to calculate rotation speed of the motor in a specific period longer than a period of the pulse based on the acquired pulse; and
a control portion configured to control the motor based on the rotation speed calculated by the calculation portion such that the rotation speed of the motor is constant.

2. The motor control system according to claim 1, wherein the control portion performs PWM control on the motor.

3. The motor control system according to claim 2, wherein the control portion makes the specific period longer in a case where a duty ratio in the PWM control is not updated.

4. The motor control system according to claim 1, further comprising a second acquisition portion configured to acquire a parameter indicating a remaining amount of the conveyed toner, wherein
the control portion changes the specific period depending on the parameter.

5. The motor control system according to claim 1, wherein, in a case where the motor starts to be driven, the control portion starts to drive the motor at rotation speed at which the motor is stopped last time.

6. A motor control method comprising:
an acquisition step of acquiring a pulse that is output from a detection portion configured to detect rotational speed of a motor configured to rotate a conveyor configured to convey toner to be removed;
a calculation step of calculating rotation speed of the motor in a specific period longer than a period of the pulse based on the acquired pulse; and
a control step of controlling the motor based on the rotation speed calculated in the calculation step such that the rotation speed of the motor is constant.
